(19) United States
(12) Patent Application Publication
(10) Pub. No.: US 2014/0206307 A1
(43) Pub. Date: Jul. 24, 2014

(54) Indoor/Outdoor Personal Security System

(71) Applicants: Michael Maurer, Woolwich Twp, NJ (US); Olajde Jaji, Pittsburgh, PA (US); Roghaua Krishua Cittineru, Deptford, NJ (US); Michael Pannacciulli, Pitman, NJ (US); Paul Campbell, Woodbury, NJ (US); Ragini Bhoopzthy, Audobon, PA (US)

(72) Inventors: Michael Maurer, Woolwich Twp, NJ (US); Olajde Jaji, Pittsburgh, PA (US); Roghaua Krishua Cittineru, Deptford, NJ (US); Michael Pannacciulli, Pitman, NJ (US); Paul Campbell, Woodbury, NJ (US); Ragini Bhoopzthy, Audobon, PA (US)

(21) Appl. No.: 13/746,338

(22) Filed: Jan. 22, 2013

(51) Int. Cl. H04W 4/22

(52) U.S. Cl. CPC H04W 4/22
USPC 455/404.2

(57) ABSTRACT

A security system uses tags that are able to receive time signals sent from the GPS satellites or the broadcasting radio signals from the cell towers and transmit the identification and location information or signals to the central database and server for triangulation/trilateration periodically or in the event of an emergency. A security system uses tags that are able to transmit RF signals to readers located around a college campus. The tags may transmit signals periodically or in the event of an emergency. Certain locations use LF readers with exciters that trigger a signal from the tag. The security system may provide quick identification and location of individuals in danger.

### BACKGROUND OF THE INVENTION

1. Field of the Invention

The invention relates to systems and methods for personal security, tracking and locating, and more particularly to systems and methods utilizing global positioning system (GPS), cellular (GSM) network, and other available technologies to locate and send out alerts with personal and location information to the assistance providers and/or law enforcement.

2. Description of Related Art

Security on school campuses is an important issue. School shootings and other forms of violent crime place students in jeopardy. Campuses also need to be concerned with other forms of crime such as rapes, muggings and robberies.

Campuses typically try to ensure the safety of their students through measures such as call boxes. Call boxes may be located hundreds of yards apart. While call boxes provide an additional measure of security on campuses they do not fully protect a student and a student may not be able to reach the box in time or a box may be damaged on malfunctioning.

There is also a need to show locations of people in distress (e.g. students, staff, etc.) even if outside the campus. Moreover, a need for systems and methods that allows tracking, locating, two way communications and providing assistance is raising for general population.

With the increasing availability of affordable global positioning system (GPS), cellular network, and wireless technology it is now possible to track students and individuals on campuses and off campus with reliable accuracy to ensure safety.

### SUMMARY OF THE INVENTION

The method and system of the present invention may be able to provide security for employees, staff and students. The system and method may provide the location of individuals to the relevant authorities, as well as video of any incidents and location update information. The system and method may further allow people in distress to notify law enforcement or anyone else they designate whenever and wherever they feel threatened.

An object of the present invention is a security system that uses tags.

Another object of the present invention is security system that may be used both indoors and outdoors, both on campus and off campus.

Another object of the present invention is to provide systems and methods that utilize GPS (Satellite triangulation/trilateration), Cellular triangulation/trilateration based off of Cell towers, Radio Frequency, Infrared, Wi-Fi, Ultrasound and whatever other new technology might be available in the future for determining tag locations.

Another object of the present invention is to provide systems and methods that allow person in distress to press the panic button, and the GPS location (latitude and longitude) and their ID is sent via built-in cellular technology for communicating the information (ID & Location) via built-in cellular technology (e.g. Verizon, AT&T, T-Mobile, Sprint) back to the central database and Server using Radio Frequency (Cellular), Wi-Fi, etc.

Another object of the present invention is a security system that allows two-way communication with the tag.

Yet another object of the present invention is to provide systems that allows the emergency calls to route through to the database and server and the server then processes the alert within seconds and routes the information to either a call center or to law enforcement in the area of the alert.

A first aspect of the present invention may be a security system comprising: a tag, wherein the tag emits signals; a first RF reader for detecting emitted signals; an LF reader for detecting emitted signals; a central database adapted to receive transmissions from the RF signal reader and the LF signal reader, wherein said central database uses the transmissions (transmitted information) to triangulate a location of the tag in an area; and wherein the LF reader further comprises an LF exciter for causing the tag to emit signals.

Another aspect of the present invention may be a security system comprising: a tag and a central database, wherein the tag containing a Global Positioning System (GPS) chip to receive signal of time transmitted from Global Positioning system (GPS) satellites, calculate current position (latitude, longitude, elevation), and the precise time, using the process of triangulation/trilateration after measuring the distance to at least four satellites by comparing the satellites' coded time signal transmissions. The tag further records the position at regular interval, and may send signals at regular intervals (provide latitude, longitude, and some may provide altitude information) or upon events to the central database and server using a text message (GPRS or SMS), radio frequency (cellular network), Wi-Fi, or satellite modem embedded in the unit. The central database and server further have the capability to display the tag's location in human readable format via text or in a graphical format (map) to be displayed against a map backdrop either in real time or when analyzing the track later, using GPS tracking software. The server then processes the alert within seconds and routes the information to either a call center or to law enforcement in the area of the alert.

Another aspect of the present invention may be a security system comprising: a tag and a central database, wherein the tag containing a radio frequency antenna/receiver to receive the broadcasting signals from cell towers near the tag and transmitter to send the signals back to the cell towers. The Mobile Telephone Switching Office (MTSO) automatically keeps track of a cell phone's relative signal and determine the location via triangulation/trilateration. The location and the ID can be provided to the central database and server which will then processes the alert within seconds and routes the information to either a call center or to law enforcement in the area of the alert.

Another aspect of the invention may be a method for providing security for an area comprising: providing a tag wherein the tag emits signals at a first time interval and a second time interval, wherein the first time interval is shorter than the second time interval; providing RF readers for detecting emitted RF signals in an area; providing LF readers for detecting emitted LF signals in the area; detecting a signal from the tag at one of the RF readers and the LF readers; transmitting the signal to a central database, wherein said central database uses the transmissions to triangulate a location of the tag in an area.

Another aspect of the invention may be a method for providing security for an area comprising: providing a tag wherein the tag and a central database; wherein the tag receives signals transmitted from GPS or Cellular network and transmits signals including location and identification to the central database/server which then processes the alert within seconds and routes the information to either a call center or to law enforcement in the area of the alert.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

The system and method provides an indoor/outdoor method and system for tracking individuals and ensuring the safety of students, staff, and faculty on campuses and off campuses and/or general population. This system and method are described in more detail below.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a block diagram of a security system, arranged in accordance with an embodiment of the present invention.

FIG. 2 is a diagram showing the activity of LF readers.

FIG. 3 is a block diagram of a tag made in accordance with an embodiment of the present invention.

FIG. 4 is a flow chart showing the method for providing security to an indoor/outdoor area.

### DESCRIPTION OF THE PREFERRED EMBODIMENT

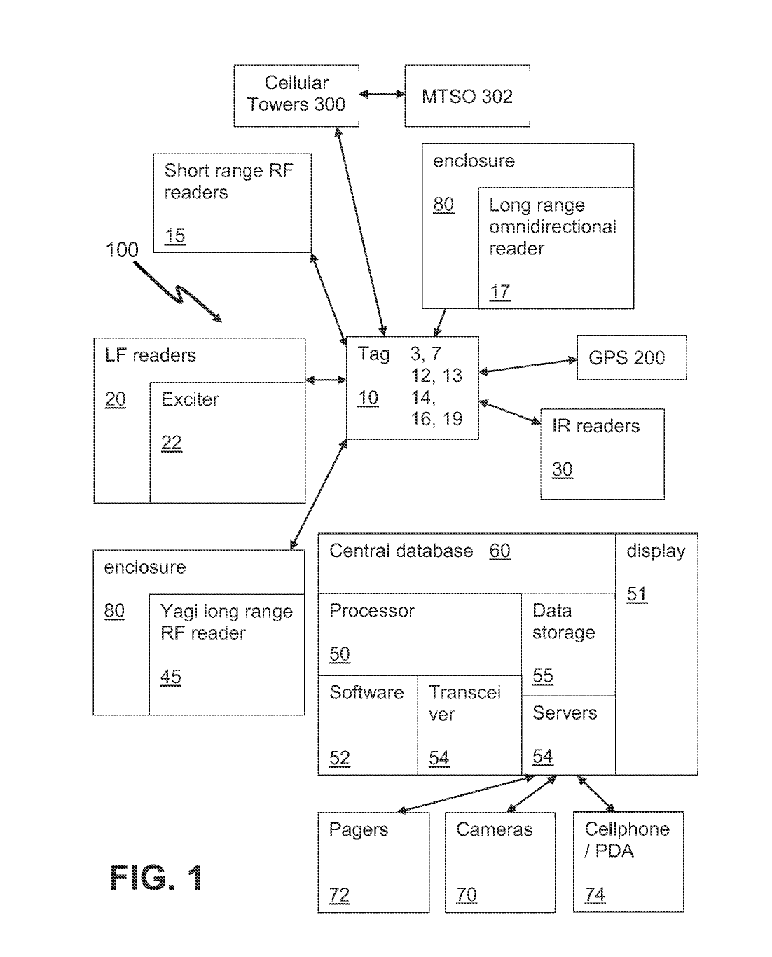

The method and system of the present invention ideally is able to provide security for employees, staff and students on campuses. A diagram of the security system 100 is shown in FIG. 1. The central component of the security system 100 is the tag 10. Each employee, staff member and student may wear a tag 10 on his or her person. Additionally, tags 10 may be attached to objects or provided to visitors. It should be understood that any individual that needs to be or requests to be protected by the security system 100 may request a tag 10 or be asked to wear one. Tags 10 may be located within or on a bracelet, a pull-away necklace, a badge, a pin, affixed to a stationary object, or in formed in a shape more conducive to attachment to equipment.

In one embodiment, the tag 10 may use a variety of technology that includes Radio Frequency (RF), Diffused Infra Red (IR), Low Frequency radio frequency (LF) and Proximity Card functionality. RF refers to a frequency range between 300 MHz and 933 MHz. LF refers to a frequency range between 30 kHz and 300 kHz. Diffused IR refers to electromagnetic radiation in the Infra Red range, which may be up encompass a sphere up to 80 feet in diameter and does not require direct line-of-sight. Proximity card functionality involves contactless integrated circuit devices used for security access or payment systems, the proximity card may be the older 125 kHz devices or newer 13.56 MHz contactless RFID cards, commonly known as contactless smartcards.

In one embodiment, the tag 10 may include a Global Positioning System (GPS) chip 12 to receive signal of time transmitted from Global Positioning system (GPS) satellites 200 and calculate current position (latitude, longitude, and altitude) and the precise time using the process of triangulation/trilateration. To elaborate the process, GPS satellites 200 broadcast signals from space, and the GPS chip 12 in the tag 10 uses these signals to calculate its three-dimensional location (latitude, longitude, and altitude) on the basis of triangulation/trilateration. First, the signal of time is sent from a GPS satellite at a given point. Next, the time difference between the GPS time and the time point when the time signal is received by the GPS chip 12 is calculated to generate the distance from the GPS chip 12 to the satellite 200. The same process will be done with three or more other available satellites 200. It is possible to calculate the position of the GPS chip 12 from the distances obtained between the GPS chip 12 and three satellites 200. The margin of error in GPS chip's position accuracy can be reduced by a fourth satellite 200. The recorded GPS position data can be stored in the GPS chip 12 or the onboard memory 14 within the tag 10, or the tag 10 may contain a transmitter 16 and antenna 3 to send their ID and the location data (latitude, longitude, and/or altitude) via built-in cellular technology (e.g. Verizon, AT&T, T-Mobile, Sprint) to a central data base 60, or Internet-connected computer, using a text message via SMS or GPRS, radio, Wi-Fi, ultrasound or satellite modem embedded in the unit. The tag 10 may further comprise a rechargeable battery 19 to provide power supply for the aforementioned electronic components.

The central database 60 further has the capability to display the tag's position in human readable format via text or in a graphical format (map) either in real time or when analyzing the track later, using GPS tracking software. The GPS tracking system embedded in the tag 10 is often configured to transmit location and telemetry input data at a set update rate or when an event (e.g. a button is pushed, a geographic boundary is crossed) triggers the tag 10 to transmit data. The Devices allow users to call for assistance and optionally allow designated carers to locate the user's position, typically within 5 to 10 metres.

In another embodiment, the tag 10 may comprise a cell phone RF receiver 13 to receive the broadcasting signals from all cell phone towers 300 near the tag 10 and a transmitter 16 and an antenna 3 to broadcast radio signals back to the cell phone towers 300. The Mobile Telephone Switching Office (MTSO) 302 is a system that automatically keeps track of a cell phone user's relative signal by monitoring readings from cell phone towers near the user and thus can determine the location based on triangulation/trilateration of multiple radio signals (strength) from the cell phone receiver to multiple nearby cell phone towers. To elaborate the location determination based on triangulation/trilateration, from a geometric/mathematical standpoint, if the distance to an item from each of three distinct points is known, the approximate location of that item in relation to the three reference points can be computed. This geometric calculation applies in the case of cell phones, since the locations of the cell towers which receive the phone's signal is known, and thus the distance of the phone from each of those antennae towers can be estimated, based upon the lag time between when the tower sends a signal to the phone and receives the answering signal back. Cell Tower triangulation/trilateration provides generalized location results with only 200-1000 meter accuracy. In many cases, there may actually be more than three cell towers receiving a phone's signal, allowing for even greater degrees of accuracy. It serves as a coverage fallback when GPS is unavailable or GPS signal may be blocked.

In other embodiments, the system 100 may comprise the following components placed in areas throughout the campus in order to provide detection of the tags 10. The system 100 may comprise a short range RF readers 15, a long range omni-directional RF readers 17, a LF readers 20 which further comprise an exciter 22, a IR readers 30, and/or a Yagi long range RF readers 45. All of the readers may be “intelligent” and have a microprocessor and associated memory in order to trigger specialized events when a tag 10 having a certain identification code passes a certain reader. These components may be placed in buildings and on the various structures around campus. The various components facilitate the transmission of information back to a central database 60. For interactive triangulation/trilateration purposes, the tags 10 may be programmed to transmit their unique ID, every 5 to 10 seconds while in motion and every 60 seconds when stationary.

The tags 10 may have tamper detection and multiple user defined alert/panic buttons 7, 8 built in. The transmissions provide notification to a central database 60 when the events occur such as a low battery, button press, tamper, temperature, or motion. The tags 10 may operate both indoors and outdoors. The tag 10 may have rechargeable or field replaceable, off-the-shelf Lithium batteries 19. These batteries may have a 3 to 5 year battery life and/or other energy saving mechanisms, such as solar cells, or motion detecting mechanisms in order to conserve battery power.

Using the security system 100, when an individual wearing a tag 10 activates the tag 10 a signal is sent that is picked up and transmitted to a central database 60. The tag 10 may be activated by pressing a button; otherwise the tag 10 may periodically emit a signal based upon the movement of the individual, as discussed above. The tag 10 may be worn or carried by an individual. When in a distress situation, such as being attacked or being injured, activation of the tag 10 may do the following: signal campus police/security and show their precise location within 2-3 meters of accuracy within all buildings on campus and line of sight outdoors on campus. The system 100 may page, email or text patrolling police/security and provide the name of the student/employee/faculty in distress and provide their precise location. The system 100 may also have existing cameras stream ‘real time’ video from the alerted location to police/security as it is happening. Additionally, the system may provide updates to police as to the location of the person in distress should they move more than a preset distance, such as 50 feet or more. The tags 10 may have an audible alert or trigger a nearby audible alert from the system 100 to alert any nearby individuals of a crime and aid police in responding to the location quickly.

The central database 60 may comprise a processor 50 and software 52 for detecting and interpreting the signals received from the tag 10, MTSO 302, RF readers 15, 17, LF readers 20 and/or IR readers 30. The central database 60 may also comprise a transceiver 54, data storage 55, servers 56 and display 51. The central database 60 may further communicate with pagers 72 and cameras 70 as well as cell phones/PDAs 74 via applications, text or email. It should be understood that the terminology “cell-phones/PDAs”, whether used separately or together herein, are used to encompass all smart-phones and hand-held electronic devices that may be capable of communicating wirelessly. The components of the security system 100 are discussed in more detail below. It should be understood that while the central processing and organization of information are discussed as being performed by the central database 60, the central database 60 may be a plurality of computer systems distributed throughout the secured area and may be accessed from more than one terminal or across multiple sites spanning miles or continents.

As shown in FIG. 1, the system 100 comprises an LF reader 20 that has a range of between 2-18 feet omni-directional. Ranges for the LF readers 20 may be greater depending on the needs of the system 100. The system 100 may also use master/slaves in order to extend the coverage provided by the LF readers 20. The system may also comprise a GPS chip 12 for receiving time signals from the GPS satellites 200 and/or a cellular phone RF receiver 13 for receiving broadcasting signals from the cell towers 300 as well as a transmitter 16 and antenna 3 for broadcasting signals back to the cell towers 300 and send signals/data/information to central database 60. The tag 10 may further comprise a memory 14, user defined alert buttons 7, motion sensor 11, clear button 5, and rechargeable battery 19.

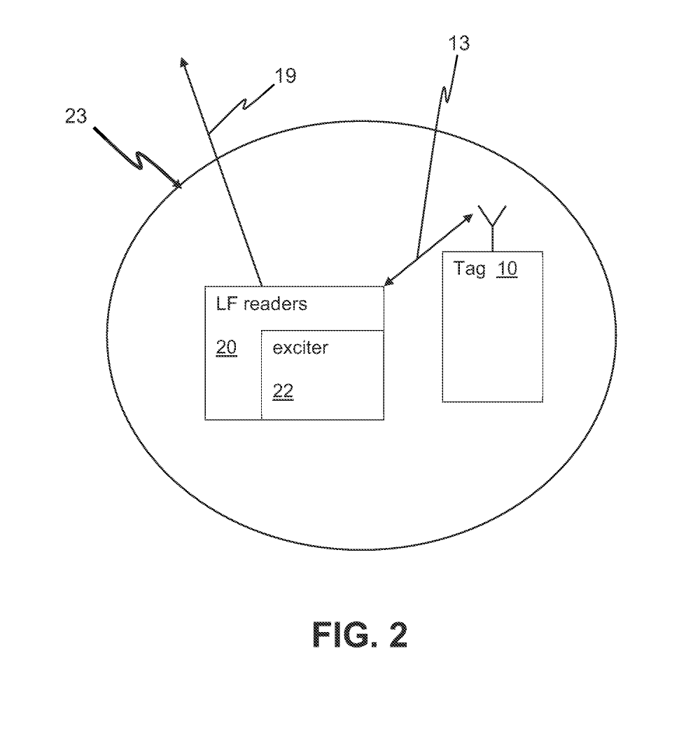

As shown in FIG. 2, the LF reader 20 may create an excitation field via an LF exciter 22 that compels the tags 10 to transmit their unique ID 24 to the LF reader 20, which then transmits the ID 24 along with the unique ID 25 of the LF reader 20 within milliseconds of the tag 10 entering the excitation field of the LF exciter 22. The LF reader 20 may be placed and implemented in locations that utilize choke point control logic. For instance an LF reader 20 may be located at entrance ways and egresses in buildings as well as in locations that force passage way. The placement may also be useful in determining inside and outside floor or site logic for the tags 10.

Now referring to FIG. 1, short range RF readers 15 are used with radio frequencies below 450 Mhz for optimum penetration of most construction types. The short range RF readers 15 are good for usage around and in buildings and other structures. The short range RF readers 15 may detect tags 10 within a 300 foot diameter (omni-directional) range, with the RF reader 15 located at the center of the range (the range emanates in a spherically). The system 100 may use received signal strength indication (RSSI) in order to determine distance from its center. This is the same technique as used with the diffused Infrared Readers 30. The RF reader 15 may have built-in supervisory functions that allow them to operate in standalone mode or alternatively be driven by the server 56 located at the central database 60. The RF reader 15 also has the ability to control relays that are activated based on user-defined business rules. For example, to lock open elevator doors or activate mag locks on doors, etc.

Omni-directional long range RF reader 17 may detect tags 10 within a spherical range up to 800 feet in diameter (omni-directional). The long range RF reader 17 has the same functions as the short range RF reader 15, but may additionally be encased in a weather proof enclosure 80 for use outdoors. This encased enclosure 80 may also contain solar cells and radio frequency or Wi-Fi transmitters.

Yagi long range RF Reader 45 may hear tags up to 2000 feet in a specific direction. Similar functionally exists for the Yagi long range RF reader 45 as the omni-directional long range RF reader 17 and the short range RF reader 15 except that its coverage is limited to approximate seventy degree radius. Much like the omni-directional long range RF reader 17, the reader 45 may be encased in a weather proof enclosure 80 for use outdoors.

An IR reader 30 may also be used to detect tags 10. These readers 30 incorporate diffused infrared which allows IR signals from tags 10 to bounce off flat surfaces to make their way back to the IR readers 30. This precludes the need for direct line-of-sight. IR signals from tags 10 may be detected in a spherical range that is up to 80 feet diameter and RSSI is used much like in the RF reader to determine distance from the center of the reader 30. Thresholds can be set on the diffused IR readers that provide for sub-room level accuracy such as tracking to the bed level when multiple beds reside in the same room.

Referring to FIG. 1, the central database 60 may have a display 51 with the ability to view and control maps showing the location of tags 10. The display 51 may use Autocad based (vector) floor and site plans. The central database 60 may incorporate intelligent boundary recognition and send locations by a transceiver 54 to pagers 72 worn by security. The central database 60 may also control CCTV cameras 70 within the vicinity of moving tags 10. The transceiver 54 also receives incoming signals from the tags 10. A central database 60 may also receive data from wireless and wired sources.

The central database 60 may also comprise a server 56. The central database 60 and the server 56 monitors tag 10 communications and trilaterate (or triangulates) their locations in real-time. The central database 60 may generate alert events based on user-defined business rules, tag events such as a button press, low battery power, motion, temperature, or tampering of the tag 10. The central database 60 may also log interfaces with the CCTV cameras 70, access control, paging, and ancillary systems. Integrated Web Services may provide usage of the server 56 services on PDAs and other web enabled wireless devices. Data back to the server is carried over dedicated infrastructure, wireless communications such as cellular or family radio band, or wireless Ethernet. Methods for communicating the information (ID & Location) back to the central database/Server may include Radio Frequency, Cellular, Satellite, Wi-Fi, or any other means of communication known in the art.

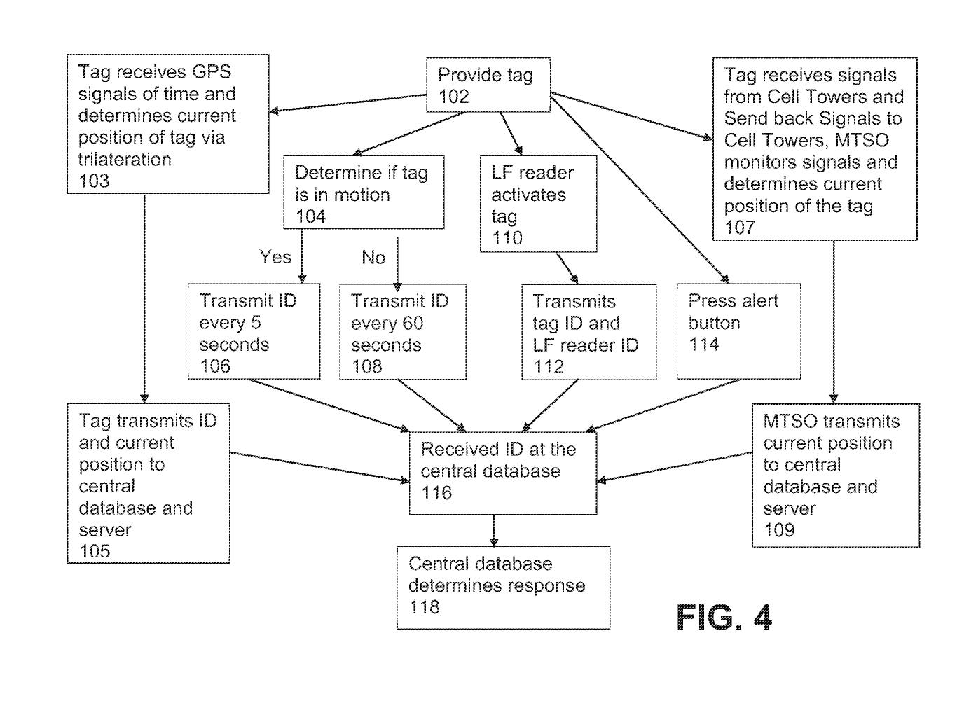

The method for providing security for an area is described in reference to the flow chart shown in FIG. 4. In step 102, tags 10 are attached to people and/or things that move about the area that is covered.

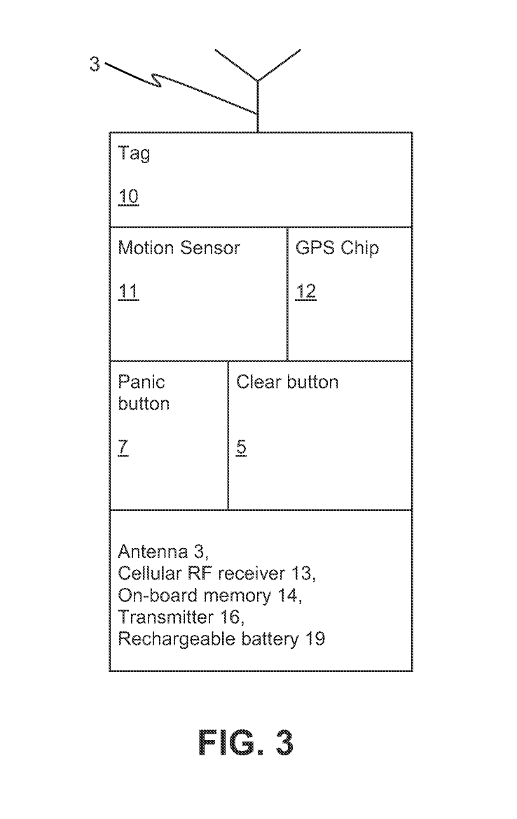

In the present invention the coverage area may include both indoors and outdoors. As shown in FIG. 3, motion sensors 11 on the tag 10 may be used to determine if the tag 10 is moving or stationary. The tag 10 may also have an antenna 3. In optional step 104, it is determined when the tag 10 is in motion. In step 106, if it is determined that the tag 10 is in motion, the unique ID 24 of the tag 10 is transmitted for a first interval of time which may be every 5 seconds, or the interval may be set within a range of 1-20 seconds. In step 108, if is determined that the tag is stationary, the unique ID 24 of the tag 10 is transmitted for a second interval of time which may be greater than every 20 seconds or longer and is preferably every 60 seconds. If there is no motion sensed 11 on the tag 10, the tag 10 transmits its unique ID 24 at a predetermined interval of time. The unique ID 24 is transmitted and detected by any and all readers within their covered range.

In optional step 103, the tag 10 receives signals of time sent from the GPS satellites and determines the current position and time via triangulation/trilateration and transmits the ID, position and time to central database 60 in step 105. Optionally, in step 107, the tag 10 receives broadcasting signals from cell towers and send back signals to the cell towers and the MTSO 302 determines current position of the tag 10 via trillateration and transmits the ID and position of the tag 10 to the central database 60 in step 109.

The tags 10 may transmit their unique ID 24 via RF or IR. In step 110, when a tag 10 is in an area covered by an LF reader 20 and exciter 22, the LF reader 20 activates the tag 10. In step 112, the tag 10 then transmits its ID 24 and the ID 25 of the LF Reader 20 every four milliseconds, which are picked up and transmitted back to the central server 60 in order to provide notification that a tag 10 has reached a specific location. This is most useful in determining when a tag 10 exits or enters a building, moves to another floor, comes onto an elevator, or when a door or camera needs to be activated quickly. The ID transmission may occur preferably within an interval range of every 1 millisecond-0.5 seconds, and at least occurs at an interval range of less than 1 second. LF readers 20 may include built-in tags that provide supervisory functions that instantly indicate when they are dysfunctional or because they are installed at finite locations, can be used to calibrate triangulation/trilateration on a constant basis.

Also shown in FIG. 3, the tag 10 may have multiple buttons on its surface that can be used to trigger events. For example, one button 7 may be used to generate a Panic Duress alert, another button 5 may be used to clear an alert. In step 114, pressing the alert button 7 will transmit both the ID 24 and the panic status. Additionally, when pressing the alert button 7, police may be notified of who pressed it and the location where it was pressed. Furthermore, since the identity of the individual who pressed their button is known the data regarding their PDA/cell-phone is entered into the system, a video and/or 2-way communications channel may be opened with the police department. In this way, police will see video streaming from the individual's PDA/cell-phone, such as an iPhone, in real-time and possibly communicate 2-way. If two cameras are present on the PDA/cell-phone both the individual use may be viewed for id confirmation and the attacker or any other situation the user may be in may be viewed.

In step 116, signals from the tags 10 related to its location are sent to and received at the central database 60 and the server 56. In one embodiment, the location of the tag 10 determined from the GPS triangulation/trilateration by the tag 10 may be sent to and received at the central database 60 and the server 56. In another embodiment, the location of the tag 10 may be provided by the MTSO 302 to the central database 60 and the server 56. Yet, in another embodiment, the GPS time and the time point that the GPS signals are received by the GPS chip 12 are sent to and received at the central database 60 and server 56 and accordingly the location of the tag 10 is triangulated (or trilaterated). In a different embodiment, tag messages from up to twelve readers may be sent to the server 56 and accordingly the location of the tag 10 is triangulated. This is similar to GPS but may occur within a building and/or outside of a building. This may be based in part on the floor logic and determined by the LF readers 20. The signals may be received at the receiver 54 or relayed to the central server 60 wirelessly or via a wired network. The received signal may contain information, such as signal strength, time received, an identification code, type of signal, event status such as low battery or panic alert, etc.

In step 118, the central database 60 determines the appropriate response to the signal. For example the central database 60 may determine which Autocad drawing file is to be called up for viewing and sounding on the display 51. Usage of the IDs with the LF readers 20 quickly enables the system 100 to determine when a tag 10 is outside and should use the outdoor site plan or when that tag 10 enters a particular building and which floor plan should be displayed. Once the site or floor plan is called up, the triangulated location of the tag 10 is positioned on its exact coordinate of the Autocad (vector) drawing file based on the xy reference locations of the readers. End users are able to easily pan and zoom in the drawing without having to learn Autocad. Accurate detail from one inch to multiple miles can instantly be viewed simply using the scroll wheel on a mouse or finger movements on touch displays.

Another response may be for the central database 60 to utilize intelligent boundary recognition to pass location of tags 10 to pagers 72, cell phones as well as web based systems and other applications, via the servers 56 and the central database 60. It may also be utilized to correlate CCTV cameras 70 with the location of moving tags 10. As tags 10 move within the boundaries of CCTV cameras 70, those cameras 70 may begin to stream video. User-friendly pan, tilt, and zoom functions may be made available within each streaming video window on the display 51 so as to quickly manage cameras 70 that can provide more insight into what is happening in the vicinity of a tag 10. Cameras 70 from multiple sites can be integrated through the central database 60 to support multi-site campuses.

Building Yagi long range RF readers 45 and long range omni-directional readers 17 into the infrastructure allows the central database 60 to track tags 10 outside as well as inside. The software 52 enables tag 10 locations to be integrated with Autocad (vector) site plans to ease panning and zooming on multi-mile campuses. The advantage of using vector drawings in the display 51 is that the end-user can zoom in to see crystal clear detail down to an inch or zoom out to see multiple miles.

The response taken by the central database 60 may be through business rules programmed into the software 52. The software 52 integrates with access control systems to provide actions based on business rules. For example: If a tag 10 enters into an area that it is not supposed to be in, actions can be set to lock/open elevator doors or to keep an elevator at a specific floor until assistance arrives. Or for example, doors can be locked to keep a tag 10 within the confines of the building or a defined zone. Any kind of audible or visual alert can be utilized based on the same business rules. Through the use of built in business rules, the police can also trigger the lock down processes from a remote location such as locking the elevators open to apprehend a suspect.

Examples of usage of the security system 100 may be for a wireless panic duress for individuals on campus. On a college campus that has the security system 100 installed, students wearing tags 10 can press one of two buttons on their tag 10 to initiate a response. If pressing one of alert/panic buttons 7, for example, it would initiate a Panic Duress Alert and accordingly, their precise location inside or outside would be triangulated and shown on an Autocad floor plan on a display 51 in the police department, along with an audible notification. Another alert/panic button 7 could be used to request assistance for example in the case where a student in a wheel chair may need assistance in getting pulled from a walk-way rut. Police would see the location of the tag 10 and the name associated with the tag 10 within seconds of button 7 being pressed. Police wandering the site would see who triggered the alert and where the alert happened on their pager 72 or preferred communication device like a cell phone or PDA. Any video cameras 70 that can see into the alerted location will automatically begin to stream video. The police are then able to pan, tilt, and zoom in any of the streaming videos to see more detail regarding an incident (cameras may support PTZ functions). Alerts can also be sent to web enabled devices and those same devices can be used to query for tag locations if enabled. Ability to track objects via web-enabled devices will include triangulation/trilateration based on GPS, and/or Cellular, and/or built-in RF, and/or built-in IR technology.

Another example may be if an individual or an object having a tag 10 comes into proximity of an exit door, the door can lock automatically until the proper authorities arrive. If the individual or object happens to exit with the tag 10, notification is sent to the central server 60 and their location is updated every time they move fifty feet. Alerts can be sent to web enabled devices and those same devices can be used to query for tag locations if enabled. The ability to track objects via web-enabled devices will include triangulation/trilateration based on GPS, and/or cellular, and/or built in RF, and/or built-in IR technology.

Still yet another example may be asset tracking and theft prevention. The security system 100 infrastructure may track assets in real-time and send alerts when an asset is in an area it shouldn't be. Doors can lock down based on proximity of an asset with a tag 10. A CCTV camera 70 can activate, audible alerts can sound, etc. Alerts can also be triggered when a visitor is separated a pre-defined distance from the asset they carried into a secure facility. End-users can query for asset locations in seconds on web enabled devices and/or desktop clients. Ability to track objects via web-enabled devices will include triangulation/trilateration based on GPS, and/or Cellular, and/or built-in RF, and/or built-in IR technology.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A security system comprising: a tag, wherein the tag receives signals from GPS satellites and determines current position of the tag via triangulation/trilateration, records the position at regular interval, transmits the position and identification of the tag via embedded transmitter and antenna at regular interval or upon events that triggers transmission including an alert; and a central database and server adapted to receive transmissions from the tag, wherein said central database and server record the position and identification and/or processes the alert within seconds and routes the information to either a call center or to law enforcement in the area of the alert.

2. The security system of claim 1, wherein the tag further receives signals broadcast from cellular towers and emits signals back to the cellular towers, the signals received by the cellular towers are monitored and used by MTSO to determine current position of the tag via triangulation/trilateration, the position and identification of the tag are then recorded and/or transmitted at regular time intervals or upon events that triggers transmission including an alert; and a central database and server adapted to receive transmissions from the MTSO, wherein said central database and server record the position and identification and/or processes the alert within seconds and routes the information to either a call center or to law enforcement in the area of the alert.

3. The security system of claim 2 further comprising a first RF reader and an LF reader; wherein the tag emits signals; the first RF reader for detecting emitted signals; the LF reader for detecting emitted signals; the central database adapted to receive transmissions from the RF signal reader and the LF signal reader, wherein said central database uses the transmissions to triangulate a location of the tag in an area; and wherein the LF reader further comprises an LF exciter for causing the tag to emit signals.

4. The security system of claim 3, wherein the first RF reader is a short range RF reader with a spherical range of up to 300 feet in diameter and/or a long range RF reader with a spherical range of up to 800 feet in diameter and/or a Yagi long range RF Reader with a directional range of up to 2000 feet.

5. The security system of claim 3, wherein the RF reader operates a frequency range between 300 MHz and 933 MHz and the LF operates in a frequency range between 30 kHz and 300 kHz.

6. The security system of claim 3, wherein the tag comprising built-in cellular technology to allow two way communication via cellular, radio frequency, and/or wi-fi.

7. The security system of claim 3, wherein the tag comprising user defined alert button such that the user can push the button to trigger transmission of the current position and identification to the central database and server.

8. The security system of claim 3, further comprising an infrared reader.

9. The security system of claim 3, further comprising a display for displaying the location of the tag in the area, wherein said display comprises a vector floor plan of said area.

10. The security system of claim 3, wherein the tag further comprises a motion detector.

11. The security system of claim 3, wherein the central database further communicates with a cell phone or PDA.

12. A method for providing security for an area, comprising: providing a tag, wherein the tag receives signals and determines current position of the tag, records, and transmits identification and position of the tag at regular time interval and/or upon events; and providing a central database and server wherein said central database receives and recording the identification and position of the tag, and/or processes the alert within seconds and routes the information to either a call center or to law enforcement in the area of the alert.

13. The method of claim 12, wherein the tag further receives signals broadcast from cellular towers and emits signals back to the cellular towers, the signals received by the cellular towers are monitored and used by MTSO to determine current position of the tag via triangulation/trilateration, the position and identification of the tag are then recorded and/or transmitted at regular time intervals or upon events that triggers transmission including an alert; and a central database and server adapted to receive transmissions from the MTSO, wherein said central database and server record the position and identification and/or processes the alert within seconds and routes the information to either a call center or to law enforcement in the area of the alert.

14. The method of claim 13 further comprising providing at least one RF reader and at least one LF reader, wherein the tag emits signals at a first time interval and a second time interval, wherein the first time interval is shorter than the second time interval; detecting a signal from the tag at one of the RF readers and the LF readers; transmitting the signal to the central database, wherein the central database uses the transmissions to triangulate a location of the tag in an area.

15. The system of claim 14, wherein the tag comprising built-in cellular technology to allow two way communication via cellular, radio frequency, and/or wi-fi.

16. The system of claim 14, wherein the tag comprising user defined alert button such that the user can push the button to trigger transmission of the current position and identification to the central database and server.

17. The system of claim 14, further comprising providing an infrared reader.

18. The system of claim 14, wherein the central database further comprising a display for displaying the location of the tag in the area, wherein said display comprises a vector floor plan of said area.

19. The system of claim 14, wherein the tag further comprises a motion detector.

20. The system of claim 14, wherein the central database further communicates with a cell phone or PDA.
